(19) United States
(12) Patent Application Publication
(10) Pub. No.: US 2021/0209164 A1
(43) Pub. Date: Jul. 8, 2021

(54) METHOD, APPARATUS, AND STORAGE MEDIUM FOR RECOMMENDING INTERACTIVE INFORMATION

(71) Applicant: BAIDU ONLINE NETWORK TECHNOLOGY (BEIJING) CO., LTD., Beijing (CN)

(72) Inventors: Wensong HE, Beijing (CN); Yafei MIAO, Beijing (CN); Qichao TANG, Beijing (CN); Ben XU, Beijing (CN); Jian XIE, Beijing (CN)

(73) Assignee: BAIDU ONLINE NETWORK TECHNOLOGY (BEIJING) CO., LTD.

(21) Appl. No.: 17/023,049

(22) Filed: Sep. 16, 2020

(30) Foreign Application Priority Data
Jan. 8, 2020 (CN) 202010017120.8

(51) Int. Cl. G06F 16/901; H04L 12/58; G10L 25/63; G06F 16/9032; G06F 40/14; G06F 40/35

(52) U.S. Cl. CPC G06F 16/9027; H04L 51/02; G06F 40/35; G06F 16/90332; G06F 40/14; G10L 25/63

(57) ABSTRACT

The disclosure provides a method, an apparatus, and a storage medium for recommending interactive information. The method includes: obtaining information of a chat statement of a user, the information of the chat statement including content of the chat statement and attribute information of the chat statement; obtaining a target reply statement matched with the content of the chat statement based on a preset matching strategy; inputting the content of the chat statement, the attribute information of the chat statement, and the target reply statement into a preset matching model to obtain recommendation information for a target function; and recommending the interactive information to the user, the interactive information including the target reply statement and the recommendation information for the target function.

### CROSS-REFERENCE TO RELATED APPLICATION

This application claims priority to Chinese Patent Application No. 202010017120.8, filed on Jan. 8, 2020, the entire contents of which are incorporated herein by reference.

### FIELD

The disclosure relates to the field of human-machine interaction techniques in computer techniques, and more particularly to a method, an apparatus, and a storage medium for recommending interactive information.

### BACKGROUND

Human-machine interaction is becoming more popular as the development of computer techniques, for example, an artificial intelligence robot may provide a user with services in production and life.

In the related art, a manner of providing services through the artificial intelligence depends on active triggering of the user. For example, the user actively gives a speech control instruction including a keyword. When the keyword is recognized through the artificial intelligence, the corresponding service is provided. However, this manner of providing services may have a low intelligence degree, and result in a weak interaction sense of the user.

### SUMMARY

A first aspect of embodiments of the disclosure provides a method for recommending interactive information. The method includes: obtaining information of a chat statement of a user, the information of the chat statement including content of the chat statement and attribute information of the chat statement; obtaining a target reply statement matched with the content of the chat statement based on a preset matching strategy; inputting the content of the chat statement, the attribute information of the chat statement, and the target reply statement into a preset matching model to obtain recommendation information for a target function; and recommending the interactive information to the user, the interactive information including the target reply statement and the recommendation information for the target function.

A second aspect of embodiments of the disclosure provides an electronic device. The electronic device includes at least one processor and a memory. The memory is communicatively coupled to the at least one processor. The memory is configured to store instructions executable by the at least one processor. When the instructions are executed by the at least one processor, the at least one processor is caused to implement the method for recommending the interactive information according to the above embodiments.

A third aspect of embodiments of the disclosure provides a non-transitory computer readable storage medium having computer instructions stored thereon. The computer instructions are configured to cause a computer to execute the method for recommending the interactive information according to the above embodiments.

### BRIEF DESCRIPTION OF THE DRAWINGS

The accompanying drawings are used for better understanding the solution, and do not constitute a limitation of the disclosure.

FIG. 1 is a flowchart illustrating a method for recommending interactive information according to some embodiments of the disclosure.

FIG. 2 is a schematic diagram illustrating a first tree-structure model according to some embodiments of the disclosure.

FIG. 3 is a schematic diagram illustrating a second tree-structure model according to some embodiments of the disclosure.

FIG. 4 is a schematic diagram illustrating a second tree-structure model according to some embodiments of the disclosure.

FIG. 5 is a schematic diagram illustrating a scene for implementing a method for recommending interactive information to according to some embodiments of the disclosure.

FIG. 6 is a block diagram illustrating an apparatus for recommending interactive information according to some embodiments of the disclosure.

FIG. 7 is a block diagram illustrating an electronic device capable of implementing a method for recommending interactive information according to some embodiments of the disclosure.

### DETAILED DESCRIPTION

Description will be made below to exemplary embodiments of the disclosure with reference to accompanying drawings, which includes various details of embodiments of the disclosure to facilitate understanding, and should be regarded as merely exemplary. Therefore, it should be recognized by the skilled in the art that various changes and modifications may be made to the embodiments described herein without departing from the scope and spirit of the disclosure.

Meanwhile, for clarity and conciseness, descriptions for well-known functions and structures are omitted in the following description.

A method and an apparatus for recommending interactive information according to some embodiments of the disclosure will be described below with reference to the accompanying drawings. An executive subject of the method for recommending the interactive information in some embodiments of the disclosure is a product such as an artificial intelligence robot.

In order to improve an interaction sense, the disclosure provides a method for recommending interactive information, which may automatically feedback a reply statement and recommend information for a corresponding function based on chat information of a user. For example, when the user inputs a chat statement “I′m off work”, “Thank you for your hard work, and wash up and go to sleep” may be fed back and “do you want to listen to music” may be recommend based on the method for recommending the interactive information according to the disclosure. Therefore, the user is like chatting with a “people”, and feels a strong interaction, which greatly improves a stickiness between the user and the product, and does not require the user to input control information including a detailed control keyword.

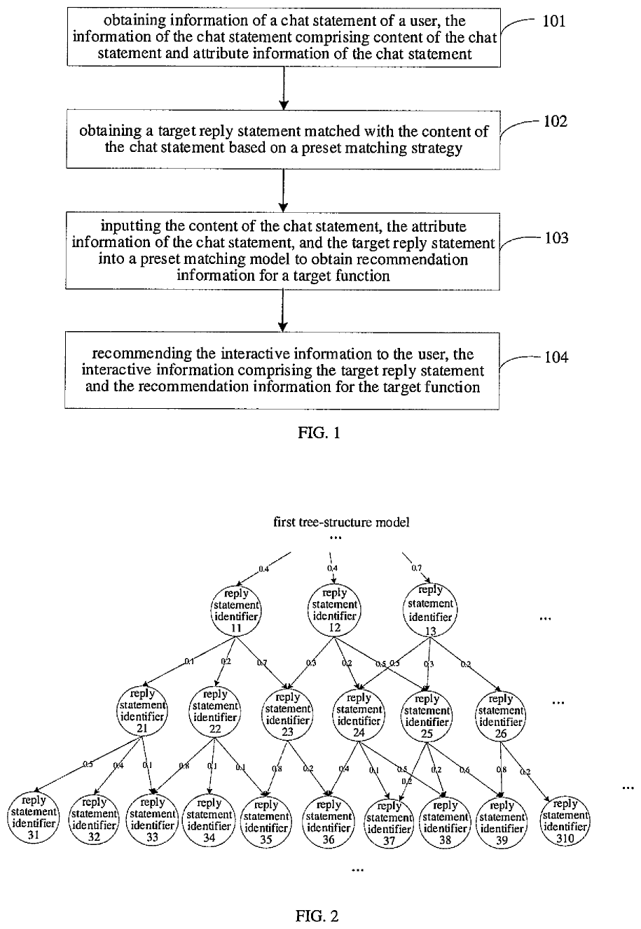

In detail, FIG. 1 is a flowchart illustrating a method for recommending interactive information according to some embodiments of the disclosure. As illustrated in FIG. 1, the method includes the following.

At block 101, information of a chat statement of a user is obtained. The information of the chat statement includes a content of the chat statement and attribute information of the chat statement.

The content refers to detail of the chat statement. The attribute information refers to an identifier of the user, a moment of sending the chat statement, an identifier of a device for receiving the chat statement, etc.

In detail, in some embodiments, the chat statement of the user may be obtained based on a device such as a microphone, and the identifier of the user may be determined based on voiceprint information of the user.

At block 102, a target reply statement matched with the content of the chat statement is obtained based on a preset matching strategy.

In detail, obtaining the target reply statement matched with the content of the chat statement based on the preset matching strategy is to automatically match the target reply statement for the user.

It should be noted that, the preset matching strategies may be different in different scenes. Examples are as follows.

Example one: semantic features of the content of the chat statement may be extracted, and the semantic features may be input into a pre-built matching model to obtain the corresponding target reply statement.

Example two: a first tree-structure model is preset. As illustrated in FIG. 2, the preset first tree-structure model includes a plurality of nodes, and each of the plurality of nodes corresponds to a reply statement identifier. A path between adjacent nodes for representing a statement probability corresponding to a statement pointed by an end of the path. It should be understood that, in the preset first tree-structure model, an order among the plurality of nodes limits a relationship among answers and replies. For example, a child node has a reply statement corresponding to an answer of a parent node.

In detail, a statement identifier corresponding to the content of the chat statement is obtained. The statement identifier may be a code, characters or numbers corresponding to the content of the chat statement. The statement identifier is matched with the preset first tree-structure model. The order among the plurality of nodes marks the relationship among the answers and the replies. Therefore, a node matched with the statement identifier has at least one subordinate node, that is, at least one candidate node matched successfully may be obtained, and then the target node is determined from the at least one candidate node based on the corresponding statement probability. For example, the candidate node with the highest statement probability is determined as the target node, and the reply statement corresponding to the target node is determined as the target reply statement.

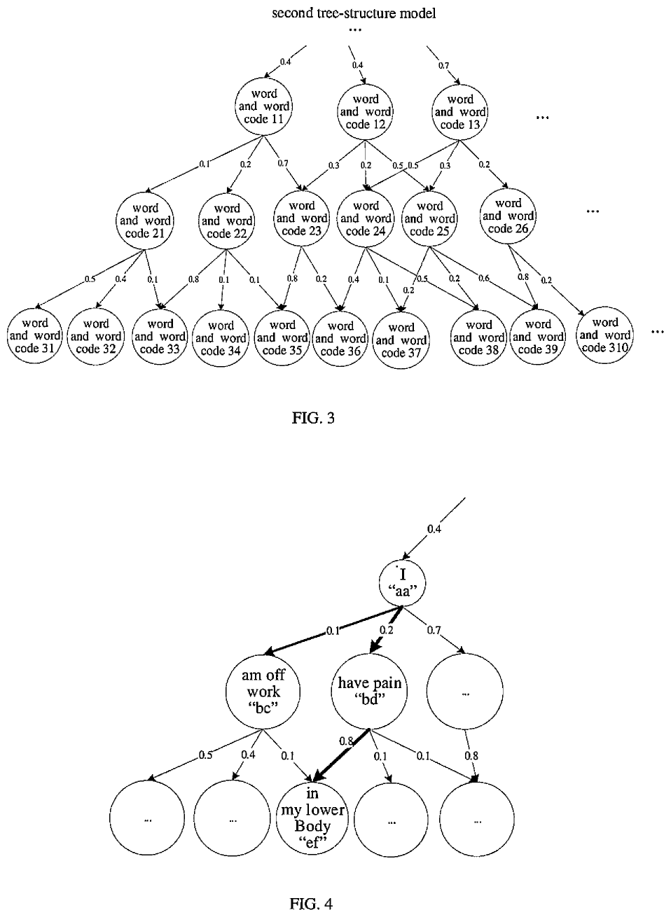

In addition, it should be noted that, in different scenes, the ways for obtaining the statement identifier corresponding to the content of the chat statement may be different. As a possible implementation, when the statement identifier is a statement code, a second tree-structure model as illustrated in FIG. 3 is preset. The second tree-structure model includes a plurality of nodes. Each of the plurality of nodes corresponds to a word and a corresponding word code. A path between adjacent nodes for representing a word probability of a word pointed by an end of the path. Referring to FIG. 3, for different nodes, corresponding subordinate nodes may be the same, that is, for some words with same semantics, the obtained word codes include the same recognition result. In addition, in the second tree-structure model, the different orders among the plurality of nodes define different matched paths.

In some embodiments, word segmentation is performed on the content of the chat statement to generate at least one segmented word. For example, after de-noising is performed on the content of the chat statement, the at least one segmented word is obtained based on part-of-speech of words included in the content of the chat statement. Then, the at least one segmented word is matched with the preset second tree-structure model based on a composition order of the at least one segmented word, to obtain at least one candidate path matched successfully. A candidate statement code corresponding to each of the at least one candidate path is generated based on word codes corresponding to nodes in each of the at least one candidate path. That is, the word codes of the nodes passed by the candidate path are connected in series to generate the candidate statement code.

There are a plurality of candidate paths due to the diversity of the segmented words generated after the word segmentation is performed.

For example, as illustrated in FIG. 4, one of the at least one candidate path (a bold part in the figure) passes word “I” and word “am off work”, the generated candidate statement code is “aabc”. Another candidate path (another bold part in the picture) passes word “I”, “have pain” and “in my lower body”, the generated candidate statement code is “aabdef”. Thus, a probability of each of the at least one candidate path is obtained based on the probabilities of the passed words. For example, the probability of each of the at least one candidate path is determined based on an average value of the probabilities of the words which the candidate path passes. Then, a target statement code is determined from at least one candidate statement code based on the probability of each of the at least one candidate path, and the statement identifier is generated based on the target statement code. For example, for the above two candidate paths, the average value of the probabilities of the first candidate path is 0.05, and the average value of the probabilities of the second candidate path is 0.5. Therefore, the second candidate path is selected as the target path, and the words corresponding to the target statement are combined into the target statement.

In an actual execution procedure, for the content of the same chat statement, different tones spoken by the user may have different meanings. For example, for a chat content “after work, I am exhausted today”, if it is said in a depressed tone, it indicates that the user is really tired, and if it is said in a lively tone, it indicates that the user is excited at this time. Therefore, in order to further improve the accuracy of the target reply statement, in some embodiments of the disclosure, voiceprint feature information of the content of the chat statement of the user may also be extracted based on a pre-constructed neural network model. An emotion of the user is determined based on the voiceprint feature information, and an emotion code is determined based on the emotion. The emotion code is added behind the target statement code to form a final target statement code. Thus, the target reply statement obtained based on the target statement code is more consistent with an emotional state of the user.

At block 103, the content of the chat statement, the attribute information of the chat statement and the target reply statement are inputted into a preset matching model to obtain recommendation information for a target function. The recommendation information for the target function is recommendation information covering a detailed function. The recommendation information is similar to chat information and more humanized, such as, including “do you want to play some music to relax” corresponding to a music service function, and “watch a TV” corresponding to a video play function.

In some embodiments of the disclosure, in order to provide more humanized service for the user, the content of the chat statement, the attribute information of the chat statement and the target reply statement are input into the preset matching model, to obtain the recommendation information for the target function. The preset matching model may correspond to the neural network model. It should be emphasized that, the recommendation information for the target function is also combined with the target reply statement, thereby ensuring the consistency between the recommendation information for the target function recommended to the user and the target chat statement, and increasing the intelligence of the product.

As a possible implementation, the content of the chat statement, the attribute information of the chat statement and the target reply statement are inputted into the preset matching model to obtain a plurality of candidate function labels and a plurality of function probabilities corresponding to the plurality of candidate function labels. A candidate function label corresponds to a detailed candidate function. In a preset database, a correspondence between the plurality of candidate function labels and recommendation information for a plurality of corresponding candidate functions is preset. Recommendation information for a candidate function corresponding to each of the plurality of candidate function labels is obtained by querying the preset database. The recommendation information for the target function is determined from the recommendation information for all the candidate functions based on the function probabilities, for example, the recommendation information for one candidate function, with a largest probability, is determined as the recommendation information for the target function.

In some embodiments of the disclosure, in order to further improve the humanization of the service, different tone conversion may be performed on the recommendation information for the target function for different users to generate a final recommendation information for the target function. For example, a voiceprint feature of the user is recognized, and when it is determined that the user is a younger, the recommendation information for the target function is processed in a lively tone, for example, popular words are added to meet a characteristic of the user.

It should be understood that, in some embodiments, the candidate recommendation information may have repeatability. For example, candidate recommendation information “play music” and candidate recommendation information “play pop music” for a music play function are obviously repetitive. However, different candidate recommendation information for the same function may have different function levels. Based on the above example, a function level of “play pop music” is obviously more detailed, which is lower than that of “play music”. The candidate recommendation information in a lower function level may obviously meet a functional requirement of the user. In this case, function levels of a plurality of pieces of candidate recommendation information are determined. For example, a function label in the candidate recommendation information is recognized, and the preset database is queried based on the function label to obtain a function level. In this embodiment, the higher function level, the more general the function included in the candidate recommendation information is.

Further, candidate reference recommendation information in a lowest function level is determined, and candidate non-reference recommendation information is deleted from the plurality of pieces of candidate recommendation information with corresponding to respective candidate function labels. That is, before the recommendation information for the target function is determined from all the pieces of candidate recommendation information based on the function probabilities, for recommendation belonging to the same function type, more detailed (lower level) candidate recommendation information is reserved.

As another possible implementation, an intention of the user may be recognized based on a keyword and a modal particle included in the information of the chat statement of the user, and the intention of the user, the content of the chat statement, the attribute information of the chat statement and the target reply statement are inputted into the preset matching model, to obtain the recommendation information for the target function.

At block 104, the interactive information is recommended to the user. The interactive information includes the target reply statement and the recommendation information for the target function.

In detail, the target reply statement and the recommendation information for the target function are fed back to the user, such as, fed back in a form of a speech, in form of text information displayed on a display screen of a robot, and fed back the target reply statement and the recommendation information for the target function in a sequence.

Further, in some embodiments of the disclosure, feedback information from the user is received. When the feedback information meets a function launching condition, for example, the user feeds back the feedback information including a keyword such as “confirm”, the function corresponding to the recommendation information for the target function is launched. In some embodiments, another chat statement may also be continuously received from the user, and then the above actions are repeated until a rejection instruction of the user is received.

In order to enable the skilled in the art more clearly understand the method for recommending the interactive information in the embodiments of the disclosure, the following description is combined with a detailed scene. In this scene, the content of the chat statement is “I am off work”.

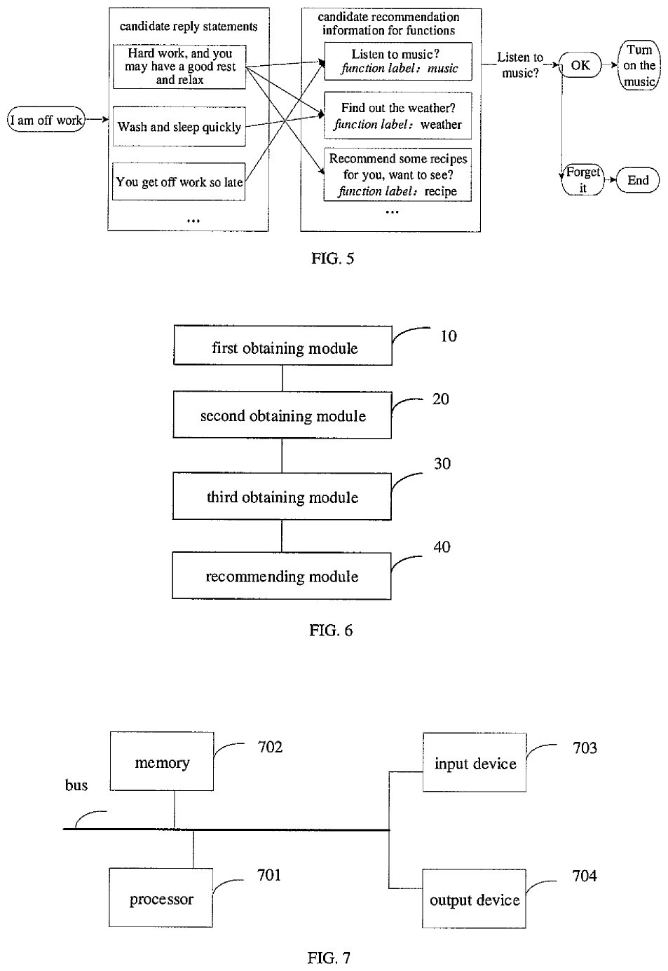

As illustrated in FIG. 5, when the content of the received chat statement is “I am off work”, candidate reply statements obtained based on the preset matching strategy include “Hard work, and you may have a good rest and relax”, “Wash and sleep quickly”, “You get off work so late” and so on. Then candidate recommendation information for functions obtained based on the preset matching model may be “Listen to music?”, “Find out the weather?”, “Recommend some recipes for you, want to see?” and so on. In this scene, a function label may be obtained first, and the corresponding recommendation information may be matched based on the recommendation function corresponding to the function label by using a natural language processing method. Referring to FIG. 5, the function label corresponding to “Listen to music?” may be “music”.

Then, in this scene, when the determined target reply statement is “You get off work so late”, the recommendation information for the target function is “Listen to music”, and next feedback information received from the user is “OK”, the music is played for the user. After the music is turned on for the user, more detailed interactive information may be continuously provided for the user based on information of the chat statement of the user. When the feedback information of the user is a chat statement “Forget it”, the chat function may be ended.

In conclusion, with the method for recommending the interactive information according to embodiments of the disclosure, the information of the chat statement of the user is obtained. Based on the preset matching strategy, the target reply statement matched with the content of the chat statement is obtained. The content of the chat statement, the attribute information of the chat statement, and the target reply statement are inputted into the preset matching model to obtain the recommendation information for the target function. The target reply statement and the recommendation information for the target function are recommended to the user. Therefore, reply statements and function recommendations may be provided based on chat statements of the user, which improves an intelligence degree of interaction with the user and satisfies a personalized requirement of the user.

To achieve the above embodiments, the disclosure also provides an apparatus for recommending interactive information. FIG. 6 is a block diagram illustrating an apparatus for recommending interactive information according to some embodiments of the disclosure. As illustrated in FIG. 6, the apparatus for recommending the interactive information includes: a first obtaining module 10, a second obtaining module 20, a third obtaining module 30, and a recommending module 40.

The first obtaining module 10 is configured to obtain information of a chat statement of a user. the information of the chat statement includes content of the chat statement and attribute information of the chat statement.

The second obtaining module 20 is configured to obtain a target reply statement matched with the content of the chat statement based on a preset matching strategy.

The third obtaining module 30 is configured to input the content of the chat statement, the attribute information of the chat statement and the target reply statement into a preset matching model to obtain recommendation information for a target function.

The recommending module 40 is configured to recommend the interactive information to the user. The interactive information includes the target reply statement and the recommendation information for the target function.

In some embodiments of the disclosure, the second obtaining module 20 is configured to: obtain a statement identifier corresponding to the content of the chat statement; match the statement identifier with a preset first tree-structure model to obtain at least one candidate node matched, the preset first tree-structure model including a plurality of nodes, each of the plurality of nodes corresponding to a reply statement identifier, and a path between adjacent nodes for representing a statement probability corresponding to a statement pointed by an end of the path; and determine a target node from the at least one candidate node based on the corresponding statement probability, and determine that a reply statement corresponding to the target node is the target reply statement.

Further, the second obtaining module 20 is configured to: perform word segmentation on the content of the chat statement to generate at least one segmented word; match the at least one segmented word with a preset second tree-structure model based on a composition order to obtain at least one candidate path matched, the preset second tree-structure model including a plurality of nodes, each of the plurality of nodes being corresponding to a word and a corresponding word code, and a path between adjacent nodes for representing a word probability of a word pointed by an end of the path; generate a candidate statement code corresponding to each of the at least one candidate path based on word codes corresponding to nodes in each of the at least one candidate path; obtain a probability of each of the at least one candidate path based on the probability of each word passed by each of the at least one candidate path; and determine a target statement code from at least one candidate statement code based on the probability of each of the at least one candidate path, and generating the statement identifier based on the target statement code.

In some embodiments of the disclosure, the third obtaining module 30 is configured to: input the content of the chat statement, the attribute information of the chat statement and the target reply statement into the preset matching model to obtain a plurality of candidate function labels and a plurality of function probabilities corresponding to the plurality of candidate function labels; query a preset database to obtain candidate recommendation information for a plurality of candidate functions corresponding to the plurality of candidate function labels; determine the recommendation information for the target function from the candidate recommendation information for the plurality of candidate functions based on the plurality of function probabilities.

It should be noted that, the above description of the method for recommending the interactive information is also applicable to the apparatus for recommending the interactive information according embodiments of the disclosure, of which the implementation principle is similar, which is not elaborated here.

In conclusion, with the apparatus for recommending the interactive information according to embodiments of the disclosure, the information of the chat statement of the user is obtained. Based on the preset matching strategy, the target reply statement matched with the content of the chat statement is obtained. The content of the chat statement, the attribute information of the chat statement, and the target reply statement are inputted into the preset matching model to obtain the recommendation information for the target function. The target reply statement and the recommendation information for the target function are recommended to the user. Therefore, reply statements and function recommendations may be provided based on chat statements of the user, which improves an intelligence degree of interaction with the user and satisfies a personalized requirement of the user.

According to embodiments of the disclosure, the disclosure also provides an electronic device and a readable storage medium.

As illustrated in FIG. 7, FIG. 7 is a block diagram illustrating an electronic device capable of implementing a method for recommending interactive information according to embodiments of the disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, an intelligent phone, a wearable device and other similar computing device. The components, connections and relationships of the components, and functions of the components illustrated herein are merely examples, and are not intended to limit the implementation of the disclosure described and/or claimed herein.

As illustrated in FIG. 7, the electronic device includes: one or more processors 701, a memory 702, and interfaces for connecting various components, including a high-speed interface and a low-speed interface. Various components are connected to each other by different buses, and may be installed on a common main board or in other ways as required. The processor may process instructions executed within the electronic device, including instructions stored in or on the memory to display graphical information of the GUI (graphical user interface) on an external input/output device (such as a display device coupled to an interface). In other implementations, a plurality of processors and/or a plurality of buses may be used together with a plurality of memories if desired. Similarly, a plurality of electronic devices may be connected, and each device provides some necessary operations (for example, as a server array, a group of blade servers, or a multiprocessor system). In FIG. 7, a processor 701 is taken as an example.

The memory 702 is a non-transitory computer readable storage medium provided by the disclosure. The memory is configured to store instructions executed by at least one processor, to enable the at least one processor to execute a method for recommending interactive information according to the disclosure. The non-transitory computer readable storage medium according to the disclosure is configured to store computer instructions. The computer instructions are configured to enable a computer to execute the method for recommending the interactive information according to the disclosure.

As the non-transitory computer readable storage medium, the memory 702 may be configured to store non-transitory software programs, non-transitory computer executable programs and modules, such as program instructions/modules (such as, the first obtaining module 10, the second obtaining module 20, and the third obtaining module 30 and the recommending module 40 illustrated in FIG. 6) corresponding to the method for recommending the interactive information according to embodiments of the disclosure. The processor 701 is configured to execute various functional applications and data processing of the server by operating non-transitory software programs, instructions and modules stored in the memory 702, that is, implements the method for recommending the interactive information according to the above method embodiment.

The memory 702 may include a storage program region and a storage data region. The storage program region may store an application required by an operating system and at least one function. The storage data region may store data created according to usage of the electronic device. In addition, the memory 702 may include a high-speed random-access memory, and may also include a non-transitory memory, such as at least one disk memory device, a flash memory device, or other non-transitory solid-state memory device. In some embodiments, the memory 702 may alternatively include memories remotely located to the processor 701, and these remote memories may be connected to the electronic device through a network. Examples of the above network include, but are not limited to, an Internet, an intranet, a local area network, a mobile communication network and combinations thereof.

The electronic device for performing the method for recommending the interactive information may also include: an input device 703 and an output device 704. The processor 701, the memory 702, the input device 703, and the output device 704 may be connected through a bus or in other means. In FIG. 7, the bus is taken as an example.

The input device 703 may receive inputted digital or character information, and generate key signal input related to user setting and function control of the electronic device, such as a touch screen, a keypad, a mouse, a track pad, a touch pad, an indicator stick, one or more mouse buttons, a trackball, a joystick and other input device. The output device 704 may include a display device, an auxiliary lighting device (e.g., LED), a haptic feedback device (such as, a vibration motor), and the like. The display device may include, but be not limited to, a liquid crystal display (LCD), a light emitting diode (LED) display, and a plasma display. In some embodiments, the display device may be the touch screen.

The various implementations of the system and techniques described herein may be implemented in a digital electronic circuit system, an integrated circuit system, an application specific ASIC (application specific integrated circuit), a computer hardware, a firmware, a software, and/or combinations thereof. These various implementations may include: being implemented in one or more computer programs. The one or more computer programs may be executed and/or interpreted on a programmable system including at least one programmable processor. The programmable processor may be a special purpose or general-purpose programmable processor, may receive data and instructions from a storage system, at least one input device, and at least one output device, and may transmit the data and the instructions to the storage system, the at least one input device, and the at least one output device.

These computing programs (also called programs, software, software applications, or codes) include machine instructions of programmable processors, and may be implemented by utilizing high-level procedures and/or object-oriented programming languages, and/or assembly/machine languages. As used herein, the terms “machine readable medium” and “computer readable medium” refer to any computer program product, device, and/or apparatus (such as, a magnetic disk, an optical disk, a memory, a programmable logic device (PLD)) for providing machine instructions and/or data to a programmable processor, including machine readable medium that receives machine instructions as a machine readable signal. The term “machine readable signal” refers to any signal for providing the machine instructions and/or data to the programmable processor.

To provide interaction with the user, the system and techniques described herein may be implemented on a computer. The computer has a display device (such as, a CRT (cathode ray tube) or an LCD (liquid crystal display) monitor) for displaying information to the user, a keyboard and a pointing device (such as, a mouse or a trackball), through which the user may provide the input to the computer. Other types of apparatus may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and techniques described herein may be implemented in a computing system (such as, a data server) including a background component, a computing system (such as, an application server) including a middleware component, or a computing system including a front-end component (such as, a user computer having a graphical user interface or a web browser, through which the user may interact with embodiments of the system and techniques described herein), or a computing system including any combination of the background component, the middleware components, or the front-end component. Components of the system may be connected to each other through digital data communication in any form or medium (such as, a communication network). Examples of the communication network include a local area network (LAN), a wide area networks (WAN), the Internet, and a blockchain network.

The computer system may include a client and a server. The client and the server are generally remote from each other and usually interact through the communication network. A relationship between the client and the server is generated by computer programs operated on a corresponding computer and having a client-server relationship with each other.

It should be understood that, steps may be reordered, added or deleted by utilizing flows in the various forms illustrated above. For example, the steps described in the disclosure may be executed in parallel, sequentially or in different orders, so long as a desired result of the technical solution disclosed in the disclosure may be achieved, there is no limitation here.

The above detailed implementation does not limit the protection scope of the disclosure. It should be understood by the skilled in the art that, various modifications, combinations, sub-combinations and substitutions may be made based on design requirements and other factors. Any modification, equivalent substitution and improvement made within the spirit and principle of the disclosure shall be included in the protection scope of disclosure.

What is claimed is:

1. A method for recommending interactive information, comprising:
obtaining information of a chat statement of a user, the information of the chat statement comprising content of the chat statement and attribute information of the chat statement;
obtaining a target reply statement matched with the content of the chat statement based on a preset matching strategy;
inputting the content of the chat statement, the attribute information of the chat statement, and the target reply statement into a preset matching model to obtain recommendation information for a target function; and
recommending the interactive information to the user, the interactive information comprising the target reply statement and the recommendation information for the target function.

2. The method of claim 1, wherein obtaining the target reply statement matched with the content of the chat statement based on the preset matching strategy comprises:
obtaining a statement identifier corresponding to the content of the chat statement;
matching the statement identifier with a preset first tree-structure model to obtain at least one candidate node matched, the preset first tree-structure model comprising a plurality of nodes, each of the plurality of nodes being corresponding to a reply statement identifier, and a path between adjacent nodes for representing a statement probability corresponding to a statement pointed by an end of the path; and
determining a target node from the at least one candidate node based on the corresponding statement probability, and determining that a reply statement corresponding to the target node is the target reply statement.

3. The method of claim 2, wherein obtaining the statement identifier corresponding to the content of the chat statement comprises:
performing word segmentation on the content of the chat statement to generate at least one segmented word;
matching the at least one segmented word with a preset second tree-structure model based on a composition order to obtain at least one candidate path matched, the preset second tree-structure model comprising a plurality of nodes, each of the plurality of nodes being corresponding to a word and a corresponding word code, and a path between adjacent nodes for representing a word probability of a word pointed by an end of the path;
generating a candidate statement code corresponding to each of the at least one candidate path based on word codes corresponding to nodes in each of the at least one candidate path;
obtaining a probability of each of the at least one candidate path based on the probability of each word passed by each of the at least one candidate path; and
determining a target statement code from at least one candidate statement code based on the probability of each of the at least one candidate path, and generating the statement identifier based on the target statement code.

4. The method of claim 1, wherein inputting the content of the chat statement, the attribute information of the chat statement, and the target reply statement into the preset matching model to obtain the recommendation information for the target function comprises:
inputting the content of the chat statement, the attribute information of the chat statement, and the target reply statement into the preset matching model to obtain a plurality of candidate function labels and a plurality of function probabilities corresponding to the plurality of candidate function labels;
querying a preset database to obtain candidate recommendation information for a plurality of candidate functions corresponding to the plurality of candidate function labels; and
determining the recommendation information for the target function from the candidate recommendation information for the plurality of candidate functions based on the plurality of function probabilities.

5. The method of claim 4, wherein when there are a plurality of pieces of candidate recommendation information corresponding to each of the plurality of candidate function labels, before determining the recommendation information for the target function from the candidate recommendation information for the plurality of candidate functions based on the plurality of function probabilities, the method further comprises:
determining function levels of the plurality of pieces of candidate recommendation information;
determining candidate reference recommendation information in a lowest function level; and
deleting candidate non-reference recommendation information from the plurality of pieces of candidate recommendation information corresponding to each of the plurality of candidate function labels.

6. The method of claim 1, further comprising:
receiving feedback information from the user; and
launching a function corresponding to the recommendation information for the target function when the feedback information meets a function launching condition.

7. The method of claim 1, further comprising:
extracting voiceprint features of the content of the chat statement;
determining an emotion of the user based on the voiceprint features;
determining an emotion code based on the emotion; and
adding the emotion code to follow the target reply statement.

8. The method of claim 1, wherein inputting the content of the chat statement, the attribute information of the chat statement, and the target reply statement into the preset matching model to obtain the recommendation information for the target function comprises:
recognizing an intention of the user based on a keyword and a modal particle included in the information of the chat statement; and
inputting the intention of the user, the content of the chat statement, the attribute information of the chat statement and the target reply statement into the preset matching model, to obtain the recommendation information for the target function.

9. An electronic device, comprising:
at least one processor; and
a memory, communicatively coupled to the at least one processor,
wherein the memory is configured to store instructions executable by the at least one processor, and when the instructions are executed by the at least one processor, the at least one processor is caused to implement a method for recommending interactive information, the method comprising:
obtaining information of a chat statement of a user, the information of the chat statement comprising content of the chat statement and attribute information of the chat statement;
obtaining a target reply statement matched with the content of the chat statement based on a preset matching strategy;
inputting the content of the chat statement, the attribute information of the chat statement, and the target reply statement into a preset matching model to obtain recommendation information for a target function; and
recommending the interactive information to the user, the interactive information comprising the target reply statement and the recommendation information for the target function.

10. The electronic device of claim 9, wherein obtaining the target reply statement matched with the content of the chat statement based on the preset matching strategy comprises:
obtaining a statement identifier corresponding to the content of the chat statement;
matching the statement identifier with a preset first tree-structure model to obtain at least one candidate node matched, the preset first tree-structure model comprising a plurality of nodes, each of the plurality of nodes being corresponding to a reply statement identifier, and a path between adjacent nodes for representing a statement probability corresponding to a statement pointed by an end of the path; and
determining a target node from the at least one candidate node based on the corresponding statement probability, and determining that a reply statement corresponding to the target node is the target reply statement.

11. The electronic device of claim 10, wherein obtaining the statement identifier corresponding to the content of the chat statement comprises:
performing word segmentation on the content of the chat statement to generate at least one segmented word;
matching the at least one segmented word with a preset second tree-structure model based on a composition order to obtain at least one candidate path matched, the preset second tree-structure model comprising a plurality of nodes, each of the plurality of nodes being corresponding to a word and a corresponding word code, and a path between adjacent nodes for representing a word probability of a word pointed by an end of the path;
generating a candidate statement code corresponding to each of the at least one candidate path based on word codes corresponding to nodes in each of the at least one candidate path;
obtaining a probability of each of the at least one candidate path based on the probability of each word passed by each of the at least one candidate path; and
determining a target statement code from at least one candidate statement code based on the probability of each of the at least one candidate path, and generating the statement identifier based on the target statement code.

12. The electronic device of claim 9, wherein inputting the content of the chat statement, the attribute information of the chat statement, and the target reply statement into the preset matching model to obtain the recommendation information for the target function comprises:
inputting the content of the chat statement, the attribute information of the chat statement, and the target reply statement into the preset matching model to obtain a plurality of candidate function labels and a plurality of function probabilities corresponding to the plurality of candidate function labels;
querying a preset database to obtain candidate recommendation information for a plurality of candidate functions corresponding to the plurality of candidate function labels; and
determining the recommendation information for the target function from the candidate recommendation information for the plurality of candidate functions based on the plurality of function probabilities.

13. The electronic device of claim 12, wherein when there are a plurality of pieces of candidate recommendation information corresponding to each of the plurality of candidate function labels, before determining the recommendation information for the target function from the candidate recommendation information for the plurality of candidate functions based on the plurality of function probabilities, the method further comprises:
determining function levels of the plurality of pieces of candidate recommendation information;
determining candidate reference recommendation information in a lowest function level; and
deleting candidate non-reference recommendation information from the plurality of pieces of candidate recommendation information corresponding to each of the plurality of candidate function labels.

14. The electronic device of claim 9, wherein the method further comprises:
receiving feedback information from the user; and
launching a function corresponding to the recommendation information for the target function when the feedback information meets a function launching condition.

15. A non-transitory computer readable storage medium having computer instructions stored thereon, wherein the computer instructions are configured to cause a computer to execute a method for recommending interactive information, the method comprising:
obtaining information of a chat statement of a user, the information of the chat statement comprising content of the chat statement and attribute information of the chat statement;
obtaining a target reply statement matched with the content of the chat statement based on a preset matching strategy;
inputting the content of the chat statement, the attribute information of the chat statement, and the target reply statement into a preset matching model to obtain recommendation information for a target function; and
recommending the interactive information to the user, the interactive information comprising the target reply statement and the recommendation information for the target function.

16. The non-transitory computer readable storage medium of claim 15, wherein obtaining the target reply statement matched with the content of the chat statement based on the preset matching strategy comprises:
obtaining a statement identifier corresponding to the content of the chat statement;
matching the statement identifier with a preset first tree-structure model to obtain at least one candidate node matched, the preset first tree-structure model comprising a plurality of nodes, each of the plurality of nodes being corresponding to a reply statement identifier, and a path between adjacent nodes for representing a statement probability corresponding to a statement pointed by an end of the path; and
determining a target node from the at least one candidate node based on the corresponding statement probability, and determining that a reply statement corresponding to the target node is the target reply statement.

17. The non-transitory computer readable storage medium of claim 16, wherein obtaining the statement identifier corresponding to the content of the chat statement comprises:
performing word segmentation on the content of the chat statement to generate at least one segmented word;
matching the at least one segmented word with a preset second tree-structure model based on a composition order to obtain at least one candidate path matched, the preset second tree-structure model comprising a plurality of nodes, each of the plurality of nodes being corresponding to a word and a corresponding word code, and a path between adjacent nodes for representing a word probability of a word pointed by an end of the path;
generating a candidate statement code corresponding to each of the at least one candidate path based on word codes corresponding to nodes in each of the at least one candidate path;
obtaining a probability of each of the at least one candidate path based on the probability of each word passed by each of the at least one candidate path; and
determining a target statement code from at least one candidate statement code based on the probability of each of the at least one candidate path, and generating the statement identifier based on the target statement code.

18. The non-transitory computer readable storage medium of claim 15, wherein inputting the content of the chat statement, the attribute information of the chat statement, and the target reply statement into the preset matching model to obtain the recommendation information for the target function comprises:
inputting the content of the chat statement, the attribute information of the chat statement, and the target reply statement into the preset matching model to obtain a plurality of candidate function labels and a plurality of function probabilities corresponding to the plurality of candidate function labels;
querying a preset database to obtain candidate recommendation information for a plurality of candidate functions corresponding to the plurality of candidate function labels; and
determining the recommendation information for the target function from the candidate recommendation information for the plurality of candidate functions based on the plurality of function probabilities.

19. The non-transitory computer readable storage medium of claim 18, wherein when there are a plurality of pieces of candidate recommendation information corresponding to each of the plurality of candidate function labels, before determining the recommendation information for the target function from the candidate recommendation information for the plurality of candidate functions based on the plurality of function probabilities, the method further comprises:
determining function levels of the plurality of pieces of candidate recommendation information;
determining candidate reference recommendation information in a lowest function level; and
deleting candidate non-reference recommendation information from the plurality of pieces of candidate recommendation information corresponding to each of the plurality of candidate function labels.

20. The non-transitory computer readable storage medium of claim 15, wherein the method further comprises:
receiving feedback information from the user; and
launching a function corresponding to the recommendation information for the target function when the feedback information meets a function launching condition.
